(19) United States
(12) Patent Application Publication
(10) Pub. No.: US 2015/0324189 A1
(43) Pub. Date: Nov. 12, 2015

(54) SYSTEM AND METHOD FOR A USER TO DYNAMICALLY UPDATE A MOBILE APPLICATION FROM A GENERIC OR FIRST APPLICATION WITHIN A CLASS OF APPLICATIONS TO CREATE A SPECIFIC OR SECOND APPLICATION WITH SAID CLASS OF APPLICATIONS

(71) Applicant: Quickmobile, Inc., Vancouver (CA)

(72) Inventor: Jim Udall, Vancouver (CA)

(21) Appl. No.: 14/805,372

(22) Filed: Jul. 21, 2015

Related U.S. Application Data
(63) Continuation of application No. 13/584,720, filed on Aug. 13, 2012.
(60) Provisional application No. 61/615,419, filed on Mar. 26, 2012.

(51) Int. Cl. G06F 9/445; H04L 29/08

(52) U.S. Cl. CPC G06F 8/65; H04L 67/10; H04L 67/141

(57) ABSTRACT

A method of dynamically reconfiguring a generic class mobile application in a mobile device for a specific use within that general class comprises: downloading an adaptable framework of the generic class mobile application onto the mobile device; triggering communication between a server and the mobile device, said communication directing the server to reconfigure at least one of content, presentation and function of the generic mobile application, therein creating a specific use of the generic class mobile application.

### CROSS REFERENCE TO RELATED APPLICATIONS

The present application is a continuation of U.S. patent application Ser. No. 13/584,720, filed Aug. 13, 2012, entitled “SYSTEM AND METHOD FOR A USER TO DYNAMICALLY UPDATE A MOBILE APPLICATION FROM A GENERIC OR FIRST APPLICATION WITHIN A CLASS OF APPLICATIONS TO CREATE A SPECIFIC OR SECOND APPLICATION WITH SAID CLASS OF APPLICATIONS,” which claims priority to U.S. Provisional Patent Application No. 61/615,419, filed Mar. 26, 2012, entitled “DYNAMIC MOBILE APPLICATION COMMISSIONING,” the disclosures of which are hereby incorporated by reference in their entirety.

### FIELD OF THE INVENTION

This invention relates to improvements in the field of mobile applications and use-specific tailoring of mobile applications.

### BACKGROUND OF THE INVENTION

Mobile devices and networking technologies have transformed many important aspects of everyday life. Mobile devices, such as smart phones, other cell phones, personal digital assistants, enterprise digital assistants, tablets and the like, have become a daily necessity rather than a luxury, communication tool, and/or entertainment center, providing individuals with tools to manage and perform work functions such as reading and/or writing emails, setting up calendaring events such as meetings, providing games and entertainment aspects, and/or store records and images in a permanent and reliable medium. The internet has provided users with virtually unlimited access to remote systems, information and associated applications.

As mobile devices and networking technologies have become robust, secure and reliable, ever more consumers, wholesalers, retailers, entrepreneurs, educational institutions, advocacy groups and the like are shifting paradigms and employing the these technologies to undertake business and create opportunities for meaningful engagement with users.

The increasing capabilities of mobile communications networks and mobile user devices enable the provisioning of more complex services to the users of these devices. E-Mail services, Web browsing, and even Web based services are available today for an increasing number of mobile users.

Specifically, mobile application development is the process by which application software is developed for low-power handheld devices, such as personal digital assistants, enterprise digital assistants or mobile phones. These applications are sometimes pre-installed on phones and devices during manufacture, can be downloaded by customers from various mobile software distribution platforms, or web applications delivered over HTTP which use server-side or client-side processing (e.g. JavaScript) to provide an “application-like” experience within a Web browser.

Many of these service applications include that content data is downloaded to the user device on a regular or irregular basis. Content data is understood herein as any kind of (multi)media data such as text data, image data, video data or similar data which are eventually intended for presentation to a user of a mobile user device. Examples of items of content data are advertisements, news, notifications, reminders, etc.

Often multiple such applications related to multiple content provisioning services of one or more content providers are implemented on a single user device. However, each of these applications is treated separately. For example, every single application has to be downloaded and configured by the user. Each application requires the user to configure whether and in which form a provisioning of content items is allowed, whether updates of the application are allowed, etc. This can become a cumbersome task over the time.

From the point of view of the content providers (which generally aim at providing an ever increasing diversity of services) each new service requires a considerable effort for establishing it. Consider, for example, a location-based service provided by a retailer's shop which presents a list of the retailer's goods on the mobile devices of the shop visitors. In order to introduce a similar service for the neighbouring shop, the provider needs a separate service agreement with the mobile network operator.

A new service application would need to be installed on user devices, even though this application may be very similar to another one that is already available thereon. A new user group has to be established for sending, e.g. advertisements, although there may be a large intersection between this and other, already existing user groups. These examples illustrate in which way the isolated treatment of service applications hinders the introduction of new services.

Some classes of mobile applications share a common set of functions yet vary in presentation and content. An example of such a class of mobile applications are those applications intended for use at a meeting, convention or tradeshow. In this example, common functionalities may include attendee information, speaker information, venue information. A typical manner in which such applications are developed is that every application is developed explicitly for that particular scenario. Developers may optimize the delivery of these applications, by using various techniques of re-use and re-packaging. However in the final analysis, a new and unique application is created.

So, for example, if a trade show organizer was tasked with creating a mobile application for information gathering, information sharing and navigation at a first trade show, this application would be specific with regard to branding, functionality and content for that first show. An organizer of a second trade show would have to create and new and unique application for use within that second tradeshow. This is inefficient and costly. In addition, a user will find storing multiple applications on his/her mobile device (particularly if such application used irregularly) cumbersome and invading of precious memory space.

It is an object of the present invention to obviate or mitigate at some of the above disadvantages.

### SUMMARY OF THE INVENTION

The present invention provides, in one aspect, a method of dynamically reconfiguring a generic class mobile application in a mobile device for a specific use within that general class which comprises: downloading an adaptable framework of the generic class mobile application onto the mobile device; triggering communication between a server and the mobile device, said communication directing the server to reconfigure at least one of content, presentation and function of the generic mobile application, therein creating a specific use of the generic class mobile application.

The present invention provides, in another aspect a method of dynamically reconfiguring a first specific class of mobile application within a generic class of mobile applications within a mobile device to a second specific class of mobile application within the same generic class of mobile applications, and wherein said first specific class of mobile application is dynamically reconfigurable which comprises triggering communication between a server and the mobile device, said communication directing the server to reconfigure at least one of content, presentation and function of the first mobile application by at least one of:
a) disabling at least one aspect of content, presentation and function of the first mobile application;
b) downloading form the server to the mobile application at least one aspect of content, presentation and function of the second mobile application; and
c) enabling at least one aspect of content, presentation and function of the second mobile application.

The present invention provides, in another aspect, a machine implemented method for dynamically reconfiguring a first specific class of mobile application within a generic class of mobile applications within a mobile device to a second specific class of mobile application within the same generic class of mobile applications, and wherein said first specific class of mobile application is dynamically reconfigurable (replacing a first mobile application with a second mobile application), the method comprising, in response to receiving a notification from the wireless mobile device in communication with a server, said server verifying the request and identity of mobile device; establishing a network session between the server and the mobile device; said server performing operations for reconfiguration commands received over the network session, said reconfiguration commands selected from the group consisting of: enabling functionality of second mobile application; disabling functionality of the at least a part of the first mobile application; adding/changing a presentation theme; adding/changing content associated with a function embedded in the first mobile application.

The present invention provides, in another aspect, a machine implemented system that effectuates dissemination, configuration, or provisioning of reconfigured aspects of an application on a mobile device, wherein said application is generic class mobile application for a specific use within that general class, comprising the following machine executable components:
the mobile device;
a delivery component that receives an indication from a requestor of a need for reconfiguration of the generic application, the delivery component retrieving instructions for the reconfigured aspects from an independent server, configuring the application for utilization on a mobile device, and dispatching the application to the mobile device.

The present invention provides, in another aspect, a networked apparatus comprising: a memory; a processor; a communicator; a display; and an application creation module adapted and configured to generate a first dynamically reconfigurable mobile application for delivery to one or more mobile devices wherein each of the one or more mobile devices has a device platform, said application creation module further adapated to reconfigure at least one of content, presentation and function of the firstc mobile application, therein creating a specific/second use of the first mobile application.

The present invention provides, in another aspect, non-transitory, computer-readable storage media for tangibly storing thereon computer readable instructions for a method comprising: receiving a request from a mobile device; a first mobile application communicating the request to a server causing the server to identify a mobile device type; in response to identifying the mobile device type, delivering information to the mobile device in a format suitable for display on a mobile device interface, such information reconfiguring at least one of content, presentation and function of the first mobile application, therein creating a second, specific use of the first mobile application.

This invention describes a method and system by which a single generic mobile application for a specific functionality is created. Once the single generic mobile application is deployed, however, the application itself can be dynamically reconfigured by the end user to instantly update the capabilities, resources and brandings associated with that application-in essence-providing a new application but reconfiguring the “former” application (whether the generic original or the repurposed application)—a specific instance of that class of applications. Such reconfiguration can include enabling/disabling existing generic functionality, change presentation themes to include different colors and different images, change content associated with the functions embedded in the app.

From a practical perspective, this invention allows a mobile device user to have deployed on his/her device one reconfigurable application for a wide variety of uses. The principle is user-friendly: ab initio a user downloads from a backend or remote server (or has a mobile device that comes pre-loaded with) at least one generic class of a mobile application. Upon triggering communication between a server and the mobile device (more described on this below), the server is prompted to reconfigure at least one of content, presentation and function of the generic mobile application, therein creating a specific use of the generic class mobile application. Furthermore, once the generic application has been configured in this manner, there may be one or more subsequent specific reconfigurations for other specific uses. This is achieved with one base generic reconfigurable application and as long as each configured specific application is within the same generic class of mobile application. From a user perspective, this method and system is far superior to downloading a multitude of mobile applications for every concert, store, trade show and convention, etc. . . . attended. From a creator perspective, rather than instantiate an application for every single instance of such class of applications, it is highly preferred to create a generic reconfigurable version of that application. Then at runtime, the application can be dynamically configured by having the user connect to a backend server. That backend server can then deliver to the application all the associated information to instantiate the application for the new situation/use.

These and other advantages of the invention will become apparent throughout the present disclosure.

### BRIEF DESCRIPTION OF THE FIGURES

FIG. 1 illustrates a machine-implemented system that facilitates and/or effectuates configuration, reconfiguration, dissemination, or provisioning of applications and reconfigurations of applications to mobile devices in accordance with the present invention;

FIG. 2 illustrates the inter-connection between a mobile application and a backend server and how the mobile application is (re)configured at run time; and

FIG. 3 is a block diagram showing one system in which the present invention operates.

### DETAILED DESCRIPTION OF THE INVENTION

A method, system and apparatus for management of applications within mobile devices are described herein A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays with the applications described herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### TERMS

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

The term “device” and “mobile device” refer herein to any personal digital assistants, Smart phones, other cell phones, tablets and the like.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b). The title of the present application and headings of sections provided in the present application are for convenience only, and are not to be taken as limiting the disclosure in any way.

### Applications on Mobile Devices

Applications may be pre-installed on mobile devices during manufacture or can be downloaded by users/customers from various mobile software distribution platforms, or web applications delivered over, for example, HTTP which use server-side or client-side processing (for example, JavaScript) to provide an “application-like” experience within a Web browser.

To install a mobile device application, a user will typically either drag and drop an icon to the device or click a button to agree to the installation. Uninstalling one is also straightforward, and typically involves deleting or dragging the icon away from the device. When a user uninstalls a mobile device application, he or she may also lose all the data relating to it because, in many cases, it is not stored separately. The number of applications that can be installed on a single phone depends on the phone's memory.

There are certain classes of mobile applications for which the functionality is overlapping/common. Examples of such classes include an applications for conventions or meetings, an application for real estate viewing, an application for public transit information. Rather than instantiate an application for every single instance of such class members, it is possible, as described herein, to create a generic version of that application. Then at runtime, the application can be dynamically configured by having the user connect to a (for example, backend) server. That backend server can then deliver to the application all the associated information to instantiate the application for the new situation. Though in principle this technique to any of a number of types of applications, the example included in this description focus on an application designed for meetings or conventions. It is to be understood that the scope of the present invention is not limited in this regard.

As a first step, a generic application is first constructed that embodies all of the potential functionality of a particular mobile application. In the case of a meeting application, examples of pre-constructed functionality could include aspects such as a speaker-list, an attendee-list, a venue-list, a photo gallery, and a program guide. Depending on the class of the application, there may be many different functional components built into the application.

In addition to the functionality constructed into an application, the second property associated with an instance of a class of application is the content being managed and presented. When the generic application is constructed, the template and schema for the data managed by the application is defined and may be pre-populated with some certain amount of data—enabling the constructed application to run.

Finally there are typically presentation artifacts bundled within the constructed application that include presentation data. This would include, but is not necessarily restricted to aspects like colour schemes, images, sound bites and vides. The initially constructed application may include all manner of these artifacts in order to run.

Once a constructed application is ready for download and usage by the end user, in accordance with the present invention, it may or may not actually perform any functionality—depending on the content packaged with the application. As the constructed application is merely a framework instance of a particular class of application (also referred to herein as a “generic reconfigurable application”), it may require further configuration in order to instantiate itself as a particular instance of that class of application. In one aspect, the constructed application may instantiate a simple rudimentary instance of itself. Alternatively, it may be pre-packaged with a full suite of functionality, content, and presentation resources ready to run.

It is an imperative of the constructed application however, that there be either an explicit or implicit mechanism by which the application can connect to or communicate with a server (for example backend server). Once connected, the backend server can decide—based on its own embedded rules and criteria—how the mobile application should be configured (or re-configured).

The backend server directs the mobile application to download a new configuration description. This invention may select to use XML as a description of the configuration information. However the present invention itself does not rely on XML for its implementation. Any protocol/technology may be used that would adequately describe how the mobile application should be reconfigured. Examples of other protocols are described below.

The configuration information that may be specified by the server description includes the following:
1. Specification of what particular functionality is already in the constructed application, what should be enabled and what should be disabled.
2. Source information as to where new content can be derived by the mobile application. This source information is typically and preferably hosted on a backend server and made available for download by the mobile application.
3. A collection of new presentation artifacts that the mobile application (in reconfigured form) may use. These artifacts include images, videos, audio bites, and colour schemes.
4. Any further restrictions or descriptions that would otherwise affect the behaviour of the application. These include, but are not limited to licensing restrictions, network restrictions and event reporting information.

An aspect of the disclosure is directed to a mobile application development tool stored in a memory to generate an application or a reconfigured application, which is transmitted to a mobile device. Preferably, the mobile application development tool comprises: an application creation module adaptable and configurable to generate a mobile application for delivery to one or more mobile devices wherein each of the one or more mobile devices has a device platform and wherein the mobile application identifies one or more feed sources of information; a content processor adaptable and configurable to format the one or more sources of information in a mobile device specific format prior to delivery to the one or more mobile devices; a feed server adaptable and configurable to continuously or near continuously obtain, update and deliver content from the one or more feed sources to the mobile devices.

In at least some aspects, the application creation module is adaptable and configurable to at least one or more of assess an application name for uniqueness, to assign a URL to the app, to generate an application in one or more languages, and accept an application description and accept one or more application tags. In still other aspects, the feed sources of the application development tool are selected from the group comprising RSS, RDF, ATOM, and media RSS. Additionally, the feed sources can include services and further wherein the services are selected from the group comprising Twitter, Flickr, Blogger, Wordpress, Webshots and YouTube and any other social web services. The feed sources could also be files in the format of text files, excel files, CSV, JSON, XML, Restful API, and Web-Services.

In some configurations, an application post component configurable to communicate a post having one or more of a title, content, image, link, and category. Additionally, an interface adaptable and configurable to display the mobile application in a plurality of mobile platform configurations can also be provided. An analytics module adaptable and configurable to provide one or more data elements selected from the group comprising number of apps downloaded, number of apps downloaded by platform, time, and language, number of application views, and number of apps viewed by platform, time, and language.

Another aspect of the disclosure is directed to a method for mobile application development. The method comprises, for example: creating a mobile application using an application creation module adaptable and configurable to generate a mobile application for delivery to one or more mobile devices wherein each of the one or more mobile devices has a device platform wherein the mobile application identifies one or more feed sources of information; processing content for delivery via the mobile application with a content processor adaptable and configurable to format the one or more sources of information in a mobile device specific format prior to delivery to the one or more mobile devices; configuring the mobile application for one or more mobile devices at an application server; and publishing the mobile application via the Internet.

Still another aspect of the disclosure is directed to a networked apparatus comprising: a memory; a processor; a communicator; a display; and an application maintenance module adaptable and configurable to process content adaptable and configurable to format one or more sources of information in a mobile device specific format prior to delivery to the one or more mobile devices, and a feed server adaptable and configurable to continuously or near continuously obtain, update and deliver content from the one or more feed sources.

Still another aspect of the disclosure is directed to a non-transitory, computer-readable storage media for tangibly storing thereon computer readable instructions for a method comprising: receiving a request from a mobile device; a mobile application communicating the request to a server causing the server to identify the request and type of device; in response to identifying the mobile device type, delivering information to the mobile device in a format suitable for display on a mobile device interface.

The systems and methods described herein rely on a variety of computer systems, networks and/or digital devices for operation. As will be appreciated by those skilled in the art, computing systems and web-based cross-platforms include non-transitory computer-readable storage media for tangibly storing computer readable instructions. In order to fully appreciate how the web-based cross-platform smart phone application creation and management system operates an understanding of suitable computing systems is useful. The web-based cross-platform smart phone application creation and management systems and methods disclosed herein are enabled as a result of application via a suitable computing system.

In one aspect, a computer system (or digital device), which may be understood as a logic apparatus adapted and configured to read instructions from media and/or network port, is connectable to a server and can have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an Internet connection.

It is envisioned that data relating to the present disclosure can be transmitted over such networks or connections. The computer system can be adapted to communicate with a participant and/or a device used by a participant. The computer system is adaptable to communicate with other computers over the Internet, or with computers via a server. Each computing device (including mobile devices) includes an operating system (OS), which is software, that consists of software programs and data that runs on the devices, manages the device hardware resources, and provides common services for execution of various application software. The operating system enables an application program to run on the device.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

A user launches an app created by an app creator and downloaded to the user's mobile device to view digital content items and can connect to a front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website via an app at any time. The user may include a variety of different computing devices

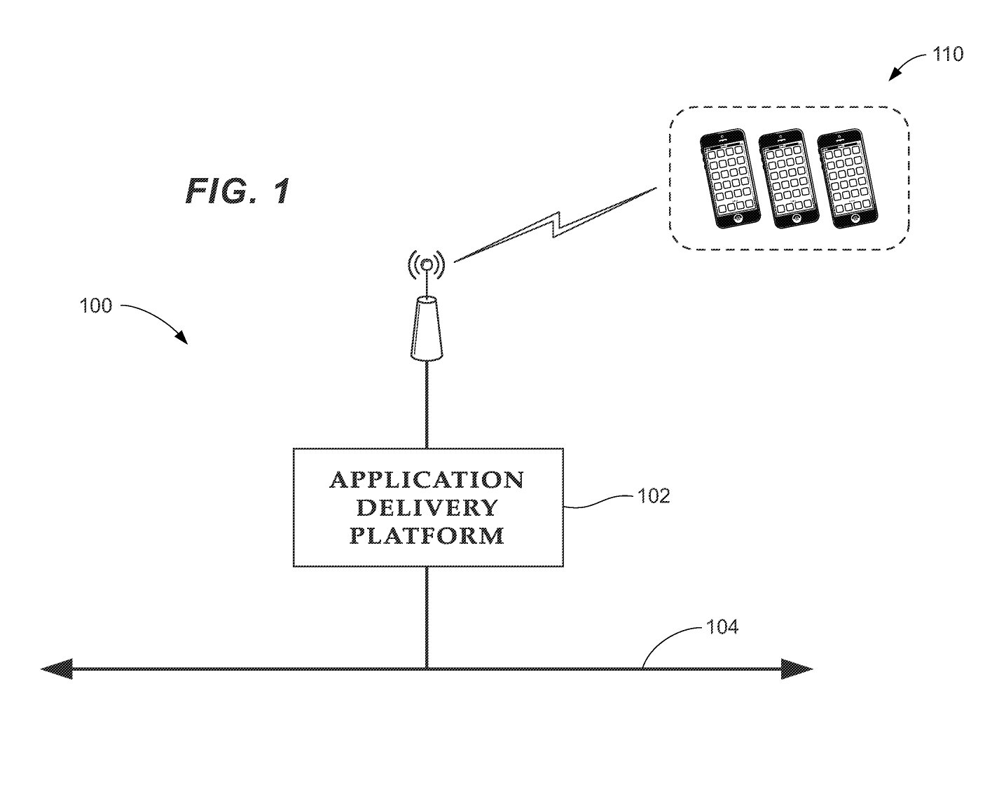

FIG. 1 illustrates a system 100 that effectuates and/or facilitates mobile application delivery and reconfiguration to a plethora of disparate mobile devices. As illustrated system 100 can include server/application delivery platform 102 that can provide the ability to download an adaptable framework of the generic class mobile application onto the mobile device; to communicate with the mobile device, said communication directing the server to reconfigure at least one of content, presentation and function of the generic mobile application, therein creating a specific use of the generic class mobile application or reconfiguring one specific use application to another specific use application.

Application delivery platform 102, as illustrated, via network topology and/or cloud 104, can be in continuous and/or operative or sporadic and/or intermittent communication with a plurality of mobile devices 110 utilizing over the air (OTA) data interchange technologies and/or mechanisms. As will be appreciated by those of reasonable skill in the art, mobile devices 110 can include a disparity of different, diverse and/or disparate portable devices including Tablet PC's, server class portable computing machines and/or databases, laptop computers, notebook computers, cell phones, smart phones, transportable handheld consumer appliances and/or instrumentation, portable industrial devices and/or components, personal digital assistants, multimedia Internet enabled phones, multimedia players, and the like.

Application delivery platform 102 can be implemented entirely in hardware and/or a combination of hardware and/or software in execution. Further, application delivery platform 102 can be incorporated within and/or associated with other compatible components. Additionally, application delivery platform 102 can be, but is not limited to, any type of machine that includes a processor and/or is capable of effective communication with network topology and/or cloud 104. Illustrative machines that can comprise application delivery platform 102 can include desktop computers, server class computing devices, laptop computers, notebook computers, Tablet PCs, consumer and/or industrial devices and/or appliances, hand-held devices, and the like.

Network topology and/or cloud 104 can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Furthermore, as those skilled in the art will appreciate and understand various data communications protocols (e.g., TCP/IP, Ethernet, Asynchronous Transfer Mode (ATM), Fiber Distributed Data Interface (FDDI), Fibre Channel, Fast Ethernet, Gigabit Ethernet, Wi-Fi, Token Ring, Frame Relay, etc.) can be utilized to implement suitable data communications.

Additionally application delivery server/platform may include a provisioning component that, based at least in part on input received from a portal component, can automatically configure and/or provision the various disparate mobile devices with appropriate applications.

It is to be appreciated that a store can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Store 206 of the subject systems and methods is intended to comprise, without being limited to, these and any other suitable types of memory. In addition, it is to be appreciated that the store can be a server, a database, a hard drive, and the like.

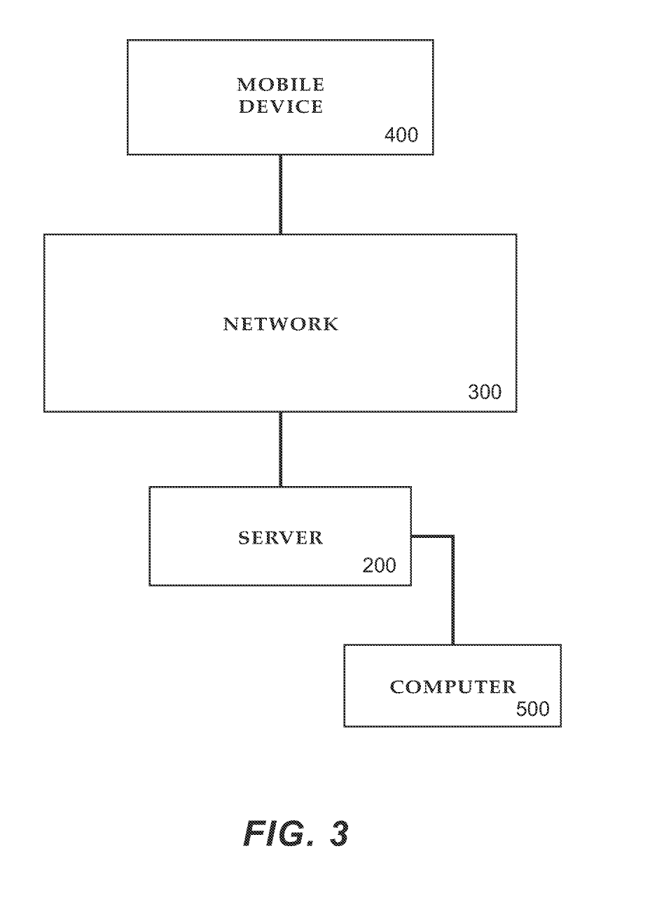

As seen in FIG. 3, an embodiment of a system according to the invention is shown. A computer 100 is a computing system and has a network link and software and/or hardware to provide instructions on application coding and reconfiguration to one or more mobile devices 400 accessible via network 300. Computer 500 may be connected to the network via server 200. Server 200 may be operated by an Internet Service Provider (ISP) or a telephone company exchange which handles the traffic from mobile and smart phones. Server 200 communicates and exchanges files with mobile devices 400 in communication with network 300. Network 300 may be the Internet, but may also be a LAN, or WAN.

### Preferred Operation

It is an object of the present invention to provide a mobile application that is generally devised to service a particular class of applications—rather than a specific instance of that class—and can be dynamically configured thru a backend server is claimed to be part of this invention.
It is an object of the present invention to provide a mobile application that can have its presentation layer substantially modified thru the downloading of a configuration file. Substantially modified includes but is not restricted to the changing of the colour scheme, replacement of locally hosted media resources including audio, video and images.
It is an object of the present invention to provide a mobile application that is driven by locally stored content, yet allows the source of that content to be changed during the execution of the application.
It is an object of the present invention to provide a method and system of using a protocol that substantially allows a backend server to substantially reconfigure an application to change content, presentation, or functionality.

The following describes the procedure that allows a generic application to be developed the (re)configured once distributed
1. The generic version of an application is constructed via conventional programming techniques. This generic reconfigurable application may be included on a device (from purchase of the device) or it may be downloaded by a user of the device. Included in the generic version are all the potential functions associated with that class of application. It is not necessary that all this functionality be exposed or immediately exposed to the end user. It is however, important that the functionality can, at the appropriate time, be exposed to the end user. In addition, default resources (such as images, colour schemes) as well as default content are built into the generic reconfigurable application. Preferably, part of the information embedded into the generic reconfigurable application is a reference to a connection point available over a standard network interface by which the generic reconfigurable application can discover and request any new configuration information.
2. If not already on a device, the generic reconfigurable application is then made available to the end consumer for use.
3. The user then activates the generic reconfigurable application and uses the application as originally designed by the developers. The resources, functionality and data set as originally deployed with the generic reconfigurable application are then made accessible to the end user.
4. There are two aspects of the method and system of the present invention, once the generic reconfigurable application is in place on the device:
   a. Via an explicit mechanism, the end user may initiate an action that causes the application the use the network to connect back to a network server. This server replies to the application that new configuration information is available. Preferably, the application initiates a logon sequence with the server. Based on the login information, the backend server would verify the credentials and take the required and programmed sequential steps; or
   b. Independent of the mobile application, an administrator of the server asynchronously creates a new configuration for the already deployed application. This new configuration enables new or disables existing functionality in the deployed application. In one aspect, it includes new artifacts and resources for the already deployed application—as well as one or more of new data and a reference to where new data can be located. This new information may either be pushed out directly to the deployed mobile application or the mobile application may poll a service to determine if the new configuration is available.
5. In either event, the deployed mobile application indicates/communicates to the end user that new configuration information is available and allows the end user to confirm acceptance of this new configuration.
6. Upon positive confirmation from the end user, the application retrieves the new information from the network server. Once received, it acts upon this new information and dynamically reconfigures itself. This reconfiguring may include the following steps:
   a. As dictated by the new configuration, install all the newly identified resources and artifacts associated with the application.
   b. As dictated by the new configuration, enable or disable the required functionality already resident in the code of the deployed application.
   c. As dictated by the new configuration, repopulate content associated with the application and any meta-data associated with that content.
7. Once reconfigured, the mobile application restarts using the new configuration information as described by the backend server.

### User Initiated Reconfiguration Protocol

In a preferred form, one means by which communication is triggered between the server and the mobile device, is via visual cues readable by the mobile device, for example visual cues readable by either a scanner and camera within the mobile device. Any visual representation of information that may be processed by vision recognition software may be used. One example of a visual cue is a QR code. Though QR Codes are used here for descriptive purposes, it is not necessary that QR Codes themselves be the technology of choice. Any visual representation of information that is easily consumed by vision recognition software may be used.

Preferably a user aims his visual cue/QR code cameral/scanner (part of mobile device) at an image containing the information about the new content/configuration. This image may be in a public place, such as a trade show, concert or other venue. Once the image is captured and recognized, typical vision recognizers will then use a technology like a web browser to connect to the backend server at the address represented by that image. The normal behaviour of the backend service associated with that address would be to detect the type of mobile device being used to render that information. Typical methods for recognizing the device type include using the UserAgent string in the HTTP header to detect the device type. Based on the UserAgent string, the backend server would then conclude that this is a mobile device of a particular type. It would then redirect the device to a location on the server where a special purpose application is available for download. Such a special purpose application is the de novo download of a generic dynamically reconfigurable application. In other words, through such redirection, the mobile device/user of mobile device may now affect its own protocols to download and install the application. Once installed, that user now falls into the category of user who already have the generic application installed.

For users with the application installed, that application would include a vision recognition component that would permit the application to view and decode the information in the exact same manner as the commonly available visual recognizer. However, once recognized, rather than resorting to the standard web browser for affecting access to the associated content, the application will now impart additional information when connecting to the backend service. When the backend service recognizes that this not as a general request, but rather a specific request from a specific application, it will perform differently. Rather than redirecting to a location where the mobile user can download and install a generic dynamically reconfigurable application, the service will now impart to the software to the mobile device such that the new configuration/reconfiguration may occur transforming the generic dynamically reconfigurable application into a specific use application.

As such, the mobile application uses retrieved/downloaded information to reconfigure/restyle/ and re-purpose itself according to the information received from the backend server.

It is an object of this aspect of the present invention to provide a mobile application that is generally devised to service a particular class of applications—rather than a specific instance of that class—and which can be dynamically configured through a backend

It is an object of this aspect of the present invention to provide a method to substantially modify the presentation layer of a mobile application by way of downloading a configuration file and using visual cues/vision recognition to initiate that information exchange. As used herein, substantially modified includes but is not restricted to the changing of the colour scheme, replacement of locally hosted media resources including audio, video and images.

It is an object of this aspect of the present invention to provide a mobile application that is driven by locally stored content, yet allows the source of that content to be changed during the execution of the application through the use of visual cues/vision technology.

Within one aspect of the method of the present invention, it is preferred that reconfiguration comprises at least one of the following: enabling functionality of at least one class of mobile application; disabling functionality of at least one class of mobile application; changing a presentation theme; changing content associated with a function embedded in the mobile application. Within one aspect of the method of the present invention, it is preferred that the reconfiguring is at runtime. Within one aspect of the method of the present invention, it is preferred that triggering communication is via visual cues readable by the mobile device. Within one aspect of the method of the present invention, it is preferred that triggering communication is via visual cues readable by the at least one of a scanner and camera within the mobile device. Within one aspect of the method of the present invention, it is preferred that triggering communication is via QR codes readable by the at least one of a scanner and camera within the mobile device. Within one aspect of the method of the present invention, it is preferred that triggering communication is directed by user at an interface on mobile device. Within one aspect of the method of the present invention, it is preferred that triggering communication is directed by at least one of environmental and location based cues. Within one aspect of the method of the present invention, it is preferred that the server asynchronously reconfigures at least one of content, presentation and function of the generic mobile application, therein creating a specific use of the generic class mobile application. Within one aspect of the method of the present invention, it is preferred that the generic class mobile application comprises sufficient data for such application to operate. Within one aspect of the method of the present invention, it is preferred that the generic class mobile application comprises presentation resource data. Within one aspect of the method of the present invention, it is preferred that triggering communication is between the server and the generic class of mobile application on the mobile device and wherein server identifies reconfiguration data required to create the specific use within that general class of application. Within one aspect of the method of the present invention, it is preferred that triggering communication is between the server and the generic class of mobile application on the mobile device and wherein server identifies at least one of content, presentation and function to be reconfigured in order to create the specific use within that general class of application. Within one aspect of the method of the present invention, it is preferred that the server directs the mobile application to expose and apply at least one content, presentation and function which pre-existed but was not previously accessible on the mobile application.

Within one aspect of the present invention, there is provided a method of dynamically reconfiguring a first specific class of mobile application within a generic class of mobile applications within a mobile device to a second specific class of mobile application within the same generic class of mobile applications, and wherein said first specific class of mobile application is dynamically reconfigurable which comprises:

triggering communication between a server and the mobile device, said communication directing the server to reconfigure at least one of content, presentation and function of the first mobile application by one or both of:
a) disabling at least one aspect of content, presentation and function of the first mobile application;
b) downloading form the server to the mobile application at least one aspect of content, presentation and function of the second mobile application; and
c) enabling at least one aspect of content, presentation and function of the second mobile application.

Within this method, it is preferred that reconfiguration comprises at least one of the following: enabling functionality of second mobile application; disabling functionality of the at least a part of the first specific class of mobile application; changing a presentation theme; changing content associated with a function embedded in the first specific class of mobile application. In a further preferred aspect of this method, the reconfiguring is at runtime. In a further preferred aspect of this method, triggering communication is via visual cues readable by the mobile device. In a further preferred aspect of this method, triggering communication is via visual cues readable by the at least one of a scanner and camera within the mobile device. In a further preferred aspect of this method, triggering communication is via QR codes readable by the at least one of a scanner and camera within the mobile device. In a further preferred aspect of this method, triggering communication is directed by user at an interface on mobile device. In a further preferred aspect of this method, triggering communication is directed by at least one of environmental and location based cues. In a further preferred aspect of this method, the server asynchronously reconfigures at least one of content, presentation and function of the first specific class of mobile application, therein creating a specific use of second specific class of mobile application. In a further preferred aspect of this method, the generic class of application is selected from the group of those useful within the context of trade shows, conventions, sporting events and venues, entertainment events and venues, charitable/fundraising events and venues, retail and real estate sales, wholesale sales, and educational events and venues.

Within one aspect of the present invention, there is provided a machine implemented method for dynamically reconfiguring a first specific class of mobile application within a generic class of mobile applications within a mobile device to a second specific class of mobile application within the same generic class of mobile applications, and wherein said first specific class of mobile application is dynamically reconfigurable (replacing a first mobile application with a second mobile application), the method comprising:

in response to receiving a notification from the wireless mobile device in communication with a server, said server verifying the request and identity of mobile device;
establishing a network session between the server and the mobile device;
said server performing operations for reconfiguration commands received over the network session, said reconfiguration commands selected from the group consisting of: enabling functionality of second mobile application; disabling functionality of the at least a part of the first mobile application; adding/changing a presentation theme; adding/changing content associated with a function embedded in the first mobile application.

Within this method, it is preferred that the reconfiguring is at runtime. In a further preferred aspect of this method notification from the wireless mobile device is triggered via visual cues readable by the mobile device. In a further preferred aspect of this method the wireless mobile device comprises a scanner or camera and notification from the wireless mobile device is triggered via visual cues readable by the at least one of a scanner and camera. In a further preferred aspect of this method the wireless mobile device comprises a scanner or camera and notification from the wireless mobile device is triggered via QR codes readable by the at least one of a scanner and camera within the mobile device. In a further preferred aspect of this method the mobile device comprises an interface through which a user prompts notification (mobile device to server) for reconfiguration.

### Technology

The methods and systems described herein may be embodied in any one or more of the following technologies.

### C

C is an imperative (procedural) systems implementation language that was designed to be compiled using a relatively straightforward compiler, to provide low-level access to memory, to provide language constructs that map efficiently to machine instructions, and to require minimal run-time support. Despite its low-level capabilities, the language was designed to encourage machine-independent programming. A standards-compliant and portably written C program can be compiled for a very wide variety of computer platforms and operating systems with little or no change to its source code, while approaching highest performance. The language has become available on a very wide range of platforms, from embedded microcontrollers to supercomputers.

### Objective-C

Objective-C is a reflective, object-oriented programming language which adds Smalltalk-style messaging to C. Objective-C is a very thin layer on top of C that implements a strict superset of C. That is, it is possible to compile any C program with an Objective-C compiler. Objective-C derives its syntax from both C and Smalltalk. Most of the syntax (including preprocessing, expressions, function declarations, and function calls) is inherited from C, while the syntax for object-oriented features was created to enable Smalltalk-style messaging.

### Java

Java is a portable, object-oriented programming language that allows computer programs written in the Java language to run similarly on any supported hardware/operating-system platform. One should be able to write a program once, compile it once, and run it anywhere. This is achieved by compiling the Java language code, not to machine code but to Java bytecode—instructions analogous to machine code but intended to be interpreted by a virtual machine (VM) written specifically for the host hardware. End-users commonly use a Java Runtime Environment (JRE) installed on their own machine for standalone Java applications, or in a Web browser for Java applets. Standardized libraries provide a generic way to access host specific features such as graphics, threading and networking. In some JVM versions, bytecode can be compiled to native code, either before or during program execution, resulting in faster execution.

### JavaScript

JavaScript is a client-side object scripting language used by millions of Web pages and server applications. With syntax similar to Java and C++, JavaScript may behave as both a procedural and object oriented language. JavaScript is interpreted at run time on the client computer and provides various features to a programmer. Such features include dynamic object construction, function variables, dynamic script creation, and object introspection. JavaScript is commonly used to provide dynamic interactivity to Web pages and interact with a page DOM hierarchy.

### Ruby

Ruby is a dynamic, reflective, general-purpose object-oriented programming language that combines syntax inspired by Perl with Smalltalk-like features. Ruby supports multiple programming paradigms, including functional, object-oriented, imperative and reflective. It also has a dynamic type system and automatic memory management; it is therefore similar in varying respects to Python, Perl, Lisp, Dylan, and CLU.

### Web Services

A Web service (also Web Service) is defined by the W3C as “a software system designed to support interoperable machine-to-machine interaction over a network”. Web services are frequently just Web APIs that can be accessed over a network, such as the Internet, and executed on a remote system hosting the requested services. The W3C Web service definition encompasses many different systems, but in common usage the term refers to clients and servers that communicate over the HTTP protocol used on the Web. RESTful Web services are Web services that are based on the concept of representational state transfer (REST).

### Representational State Transfer (REST)

Representational state transfer (REST) is a style of software architecture for distributed hypermedia systems such as the World Wide Web. An important concept in REST is the existence of resources (sources of specific information), each of which is referenced with a global identifier (e.g., a URI in HTTP). In order to manipulate these resources, components of the network (user agents and origin servers) communicate via a standardized interface (e.g., HTTP) and exchange representations of these resources (the actual documents conveying the information). For example, a resource that is a circle may accept and return a representation that specifies a center point and radius, formatted in SVG, but may also accept and return a representation that specifies any three distinct points along the curve as a comma-separated list.

### XML

The Extensible Markup Language (XML) is a general-purpose specification for creating custom markup languages. It is classified as an extensible language, because it allows the user to define the mark-up elements. XML's purpose is to aid information systems in sharing structured data, especially via the Internet, to encode documents, and to serialize data; in the last context, it compares with text-based serialization languages such as JSON, YAML and S-Expression.

### JSON

JSON is an acronym for JavaScript Object Notation, and is a lightweight data exchange format. Commonly used in AJAX applications as an alternative to XML, JSON is human readable and easy to handle in client-side JavaScript. A single function call to eval( ) turns a JSON text string into a JavaScript object. Such objects may easily be used in JavaScript programming, and this ease of use is what makes JSON a good choice for AJAX implementations.

### AJAX

AJAX is an acronym for Asynchronous JavaScript and XML but has become synonymous for JavaScript applications that use the HTTP Request object. AJAX allows websites to asynchronously load data and inject it into the website without doing a full page reload. Additionally AJAX enables multiple asynchronous requests before receiving results. Overall the capability to retrieve data from the server without refreshing the browser page allows separation of data and format and enables greater creativity in designing interactive Web applications.

### HTML Push/Comet

Comet is similar to AJAX inasmuch as it involves asynchronous communication between client and server. However, Comet applications take this model a step further because a client request is no longer required for a server response.

### Server Modules, Components, and Logic

Certain embodiments are described herein as including logic or a number of modules, components or mechanisms. A module, logic, component or mechanism (hereinafter collectively referred to as a “module”) may be a tangible unit capable of performing certain operations and is configured or arranged in a certain manner. In example embodiments, one or more computer systems (e.g. server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, mobile phones, personal digital assistants, smart phones, personal music players (like iPod) and the like. The embodiments can be practiced in distributed computing environments where tasks or modules are performed by remote processing devices, which are linked through a communications network. In a distributed computing environment, program modules may be located in both local and remote memory storage devices.

As used herein, the terms “computer” and “server” are both computing systems as described in the following. A computing system may be used as a server including one or more processing units, system memories, and system buses that couple various system components including system memory to a processing unit. Computing system will at times be referred to in the singular herein, but this is not intended to limit the application to a single computing system since in typical embodiments, there will be more than one computing system or other device involved. Other computing systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

The computing system includes a system bus that can employ any known bus structures or architectures, including a memory bus with memory controller, a peripheral bus, and a local bus. The system also will have a memory which may include read-only memory (“ROM”) and random access memory (“RAM”). A basic input/output system (“BIOS”), which can form part of the ROM, contains basic routines that help transfer information between elements within the computing system, such as during startup.

The computing system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although computing systems may employ hard disks, optical disks and/or magnetic disks, those skilled in the relevant art will appreciate that other types of non-volatile computer-readable media that can store data accessible by a computer may be employed, such a magnetic cassettes, flash memory cards, digital video disks (“DVD”), Bernoulli cartridges, RAMs, ROMs, smart cards, etc.

Various program modules or application programs and/or data can be stored in the system memory. For example, the system memory may store an operating system, end user application interfaces, server applications, and one or more application program interfaces (“APIs”).

The system memory also includes one or more networking applications, for example a Web server application and/or Web client or browser application for permitting the computing system to exchange data with sources, such as clients operated by users and members via the Internet, corporate Intranets, or other networks as described below, as well as with other server applications on servers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such as those available from Mozilla and Microsoft.

The operating system and various applications/modules and/or data can be stored on the hard disk of the hard disk drive, the optical disk of the optical disk drive and/or the magnetic disk of the magnetic disk drive.

A computing system can operate in a networked environment using logical connections to one or more client computing systems and/or one or more database systems, such as one or more remote computers or networks. The computing system may be logically connected to one or more client computing systems and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, the computing system is connected to the LAN through an adapter or network interface card (communicatively linked to the system bus). When used in a WAN networking environment, the computing system may include an interface and modem (not shown) or other device, such as a network interface card, for establishing communications over the WAN/Internet.

In a networked environment, program modules, application programs, or data, or portions thereof, can be stored in the computing system for provision to the networked computers. In one embodiment, the computing system is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances the computing system will operate automatically, where an end user application interface is provided, an operator can enter commands and information into the computing system through an end user application interface including input devices, such as a keyboard, and a pointing device, such as a mouse. Other input devices can include a microphone, joystick, scanner, etc. These and other input devices are connected to the processing unit through the end user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computing system can include other output devices, such as speakers, printers, etc.

The present methods, systems and articles also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Preferably, by using a front-end computerized method and system, a user receives and responds interactively online to a plurality of questions relating to the desired image and its characteristics, its environs and the video as a whole. A user decides and instructs on the criteria of how and where an image of a product or an advertisement is placed in a video. As an example an employee of an advertiser like Pepsi may review some videos by categories and characteristics, and provide product or advertising image insertion criteria e.g. type of scenes that should contain the placement (e.g. in kitchen scenes only), use certain size, packages and colors of products placed, confirm or provide guidelines on placement image appearance, etc. In one case this would be done in a controlled manner whereby the advertiser would be asked very direct questions on placement criteria hereby the questions are created such that the answers thereto are direct and binary: preferably yes or no. In this manner, identification and thereafter manipulation can be done quickly and effectively.

Further, in the methods taught herein, the various acts may be performed in a different order than that illustrated and described. Additionally, the methods can omit some acts, and/or employ additional acts. As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

### Example

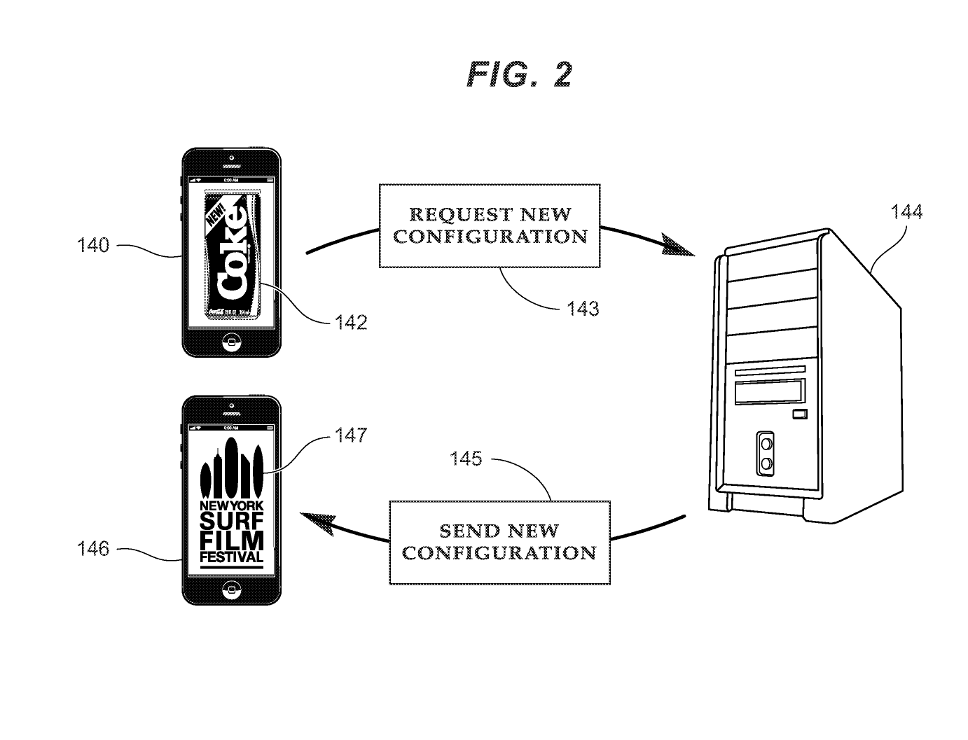

This example demonstrates, with reference to FIG. 2, the development of a generic application (and then specific reconfigured application) designed for tradeshows. The working assumption is that the tradeshow begins on a specific date and ends a matter of a few days later. This is classified as a meeting application or meeting app. Some of the functionality available to the class of meeting app potentially includes the following:

Attendee information, Speaker information, trade floor map, booth information, Vendor information, Venue information, Programme information, Social Media engagement (e.g. twitter, Facebook integration), Social Networking tools (e.g. contact exchange, locate attendee), Media clips (e.g. photos, videos, streaming broadcasts), Event Reservation

Further metrics and data and functions desirable for a trade show application:
Exhibitor & product searches
Interactive floor maps (for example, linked from Map Your Show)
Session & event schedules
Social media interaction
Exhibitor e-brochures & product info available for download to eliminate bags filled with literature

The customer for this app however has decided of the suite of potential service afforded by the app, he would only like to include the following functionality:
Venue information, Trade floor map, Vendor information

In addition, the major sponsor of this tradeshow is Coca-Cola® and he would like to brand the app with Coca-Cola colours and graphics.

The developers build a single application that includes all of the code for the full suite of services available to that class of app. That app would then be coupled with resources appropriate for the sponsorship by Coca-Cola—including colour schemes, logos and icons. Furthermore the app is initially configured to expose only the functionalities Venue information, Trade floor map, and Vendor information.

The app is built and deployed to the end user on mobile device 140, therein displaying on a screen the Coca-Cola logo at 142. When the end user launches the app, he is presented with a set of services and information associated with the tradeshow as defined by the customer.

Fast forward some period of time: the customer now wishes to re-deploy the same app for a different usage. In particular he decides to re-purpose the app to be a useful tool for a local film festival. In particular he wants the following functionality:
Venue information, Social Media, Event Reservation and Video clips

In addition, the new sponsor for the film festival is Apple®. Either the customer or some agent on behalf of that customer then defines (at computer or server 144) a new configuration that (via server mobile device communications 143 and 145) disables all previous functionality and enables only the new functionality as defined by the customer. As further part of this configuration, it defines a new colour scheme and collection of artifacts to be used by the mobile app. That information is either pushed out to the mobile app, or the mobile app as part of its normal activity requests any updates to its configuration. Once determined that a new configuration is available, the mobile app downloads this configuration.

Once downloaded the app then uses the information contained within the configuration description to reconfigure itself (device 146 is device 140 but reconfigured). The app then restarts. Upon restart, the app has now changed from being a companion generic app to the Coca-cola sponsored tradeshow to the Apple sponsored film festival (the Apple logo therein displaying on a screen at 147).

We claim:

1. A method of dynamically reconfiguring a generic class mobile application in a mobile device for a specific use within that general class which comprises:
downloading an adaptable framework of the generic class mobile application onto the mobile device;
triggering communication between a server and the mobile device, said communication directing the server to reconfigure at least one of content, presentation and function of the generic mobile application, therein creating a specific use of the generic class mobile application.

2. The method of claim 1 wherein reconfiguration comprises at least one of the following: enabling functionality of at least one class of mobile application; disabling functionality of at least one class of mobile application; changing a presentation theme; changing content associated with a function embedded in the mobile application.

3. The method of claim 1 wherein the reconfiguring is at runtime.

4. The method of claim 1 wherein triggering communication is via visual cues readable by the mobile device.

5. The method of claim 1 wherein triggering communication is via visual cues readable by the at least one of a scanner and camera within the mobile device.

6. The method of claim 1 wherein triggering communication is via QR codes readable by the at least one of a scanner and camera within the mobile device.

7. The method of claim 1 wherein triggering communication is directed by user at an interface on mobile device.

8. The method of claim 1 wherein triggering communication is directed by at least one of environmental and location based cues.

9. The method of claim 1 wherein the server asynchronously reconfigures at least one of content, presentation and function of the generic mobile application, therein creating a specific use of the generic class mobile application.

10. The method of claim 1 wherein the generic class mobile application comprises sufficient data for such application to operate.

11. The method of claim 1 wherein the generic class mobile application comprises presentation resource data.

12. The method of claim 1 wherein triggering communication is between the server and the generic class of mobile application on the mobile device and wherein server identifies reconfiguration data required to create the specific use within that general class of application.

13. The method of claim 1 wherein triggering communication is between the server and the generic class of mobile application on the mobile device and wherein server identifies at least one of content, presentation and function to be reconfigured in order to create the specific use within that general class of application.

14. The method of claim 1 wherein the server directs the mobile application to expose and apply at least one content, presentation and function which pre-existed but was not previously accessible on the mobile application.

15. A method of dynamically reconfiguring a first specific class of mobile application within a generic class of mobile applications within a mobile device to a second specific class of mobile application within the same generic class of mobile applications, and wherein said first specific class of mobile application is dynamically reconfigurable which comprises:
triggering communication between a server and the mobile device, said communication directing the server to reconfigure at least one of content, presentation and function of the first mobile application by one or both of:
a) disabling at least one aspect of content, presentation and function of the first mobile application;
b) downloading form the server to the mobile application at least one aspect of content, presentation and function of the second mobile application; and
c) enabling at least one aspect of content, presentation and function of the second mobile application.

16. The method of claim 15 wherein reconfiguration comprises at least one of the following: enabling functionality of second mobile application; disabling functionality of the at least a part of the first specific class of mobile application; changing a presentation theme; changing content associated with a function embedded in the first specific class of mobile application.

17. The method of claim 15 wherein the reconfiguring is at runtime.

18. The method of claim 15 wherein triggering communication is via visual cues readable by the mobile device.

19. The method of claim 15 wherein triggering communication is via visual cues readable by the at least one of a scanner and camera within the mobile device.

20. The method of claim 15 wherein triggering communication is via QR codes readable by the at least one of a scanner and camera within the mobile device.

21. The method of claim 15 wherein triggering communication is directed by user at an interface on mobile device.

22. The method of claim 15 wherein triggering communication is directed by at least one of environmental and location based cues.

23. The method of claim 15 wherein the server asynchronously reconfigures at least one of content, presentation and function of the first specific class of mobile application, therein creating a specific use of second specific class of mobile application.

24. The method of claim 15 wherein the generic class of application is selected from the group of those useful within the context of trade shows, conventions, sporting events and venues, entertainment events and venues, charitable/fundraising events and venues, retail and real estate sales, wholesale sales, and educational events and venues.

25. A machine implemented method for dynamically reconfiguring a first specific class of mobile application within a generic class of mobile applications within a mobile device to a second specific class of mobile application within the same generic class of mobile applications, and wherein said first specific class of mobile application is dynamically reconfigurable (replacing a first mobile application with a second mobile application), the method comprising:
in response to receiving a notification from the wireless mobile device in communication with a server, said server verifying the request and identity of mobile device;
establishing a network session between the server and the mobile device;
said server performing operations for reconfiguration commands received over the network session, said reconfiguration commands selected from the group consisting of: enabling functionality of second mobile application; disabling functionality of the at least a part of the first mobile application; adding/changing a presentation theme; adding/changing content associated with a function embedded in the first mobile application.

26. The method of claim 25 wherein the reconfiguring is at runtime.

27. The method of claim 25 wherein notification from the wireless mobile device is triggered via visual cues readable by the mobile device.

28. The method of claim 25 wherein wireless mobile device comprises a scanner or camera and notification from the wireless mobile device is triggered via visual cues readable by the at least one of a scanner and camera.

29. The method of claim 25 wherein wireless mobile device comprises a scanner or camera and notification from the wireless mobile device is triggered via QR codes readable by the at least one of a scanner and camera within the mobile device.

30. The method of claim 25 wherein the mobile device comprises an interface through which a user prompts notification (mobile device to server) for reconfiguration.

31. A networked apparatus comprising: a memory; a processor; a communicator; a display; and an application creation module adapted and configured to generate a first dynamically reconfigurable mobile application for delivery to one or more mobile devices wherein each of the one or more mobile devices has a device platform, said application creation module further adapted to reconfigure at least one of content, presentation and function of the first mobile application, therein creating a specific/second use of the first mobile application.
